(19) United States
(12) Patent Application Publication
(10) Pub. No.: US 2010/0053286 A1
(43) Pub. Date: Mar. 4, 2010

(54) LIQUID SUPPLY DEVICE AND LIQUID EJECTING APPARATUS

(75) Inventor: Hiroyuki ITO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/551,778

(22) Filed: Sep. 1, 2009

(30) Foreign Application Priority Data
Sep. 2, 2008 (JP) 2008-224859
Sep. 2, 2008 (JP) 2008-224868

(51) Int. Cl. B41J 2/175

(52) U.S. Cl. 347/93

(57) ABSTRACT

A liquid supply device includes: a de-foaming chamber for removing air bubbles mixed in liquid; a liquid flow path which supplies the liquid to the de-foaming chamber; a filter section provided in the liquid flow path and having an introduction portion for introducing the liquid and a discharge portion for discharging the liquid, where the discharge portion is disposed at a position with a height equal to or more than that of the introduction portion in the vertical direction; and a pressurizing section for supplying the pressurized liquid to the filter section.

### CROSS REFERENCES TO RELATED APPLICATIONS

This application is an application claiming the right of priority under the Paris Convention based on Japanese Patent Application Nos. 2008-224859 and 2008-224868 filed with the Japan Patent Office on Sep. 2, 2008, the entire contents of which are incorporated herein by reference.

### BACKGROUND

1. Technical Field

The present invention relates to a liquid supply device and a liquid ejecting apparatus for ejecting liquid.

2. Related Art

Heretofore, in an ink jet type printer, there are cases where a filter section is provided for trapping dust and grit in an ink supply section which supplies ink in an ink cartridge to a recording head. A filter used in the filter section has fine meshes and is apt to trap air bubbles mixed in ink, and therefore there has been a problem that the flowing of ink is obstructed by the trapped air bubbles, which causes ink discharging defects. In order to solve this problem, technology has been proposed to secure the flow path of ink even if air bubbles are trapped by the filter (JP-A-5-77440 and JP-A-6-336034). Further, there is a case where air bubbles are generated in ink in the ink supply section which supplies ink contained in the ink cartridge, etc. to the recording head, and there is known that these air bubbles cause discharging defects. In order to solve this problem, technology has been proposed in which a space (de-foaming chamber) for temporarily collecting ink is provided on the upstream side of the recording head and a de-foaming pressing is performed in the de-foaming chamber (JP-A-2006-95878).

However, even if the ink flow path has been secured, the supply of ink is poor compared with a state where air bubbles are not trapped, and therefore there was a possibility that the ink discharging defect occurs. Further, this problem is not limited to the ink jet type printer, but may also arise in any liquid ejecting apparatus which ejects liquid such as lubricant oil, resin liquid, or the like.

Also, even if the de-foaming chamber is provided, in the case where the filter for trapping dust and grit is provided on the upstream side of the de-foaming chamber, there are cases where, if air bubbles are trapped by the filter, de-foaming cannot be performed in the de-foaming chamber, and in addition, the flowing of ink is obstructed by the trapped air bubbles, which causes ink discharging defects. Further, this problem is not limited to an ink jet type printer, but may also arise in any liquid ejecting apparatus which ejects liquid such as lubricant oil, resin liquid, or the like.

### SUMMARY

An advantage of some aspects of the invention is that it suppresses air bubbles from obstructing the flow of liquid in a filter section.

Another advantage of some aspects of the invention is that it excellently removes air bubbles from liquid in a liquid supply device.

The invention takes aspects described below.

According to a first aspect of the invention, there is provided a liquid supply device including: a filter section having an introduction portion for introducing liquid and a discharge portion for discharging liquid, where the discharge portion is disposed at a position with a height equal to or more than that of the introduction portion in the vertical direction; and a pressurizing section for supplying the pressurized liquid to the filter section.

In the liquid supply device according to the first aspect, since in the filter section, the discharge portion is disposed at the position of a height equal to or more than that of the introduction portion in the vertical direction and the liquid pressurized by the pressurizing section is supplied, the obstruction of the flow of liquid by the air bubbles may be suppressed.

In the liquid supply device according to the first aspect, the configuration may also be arranged such that the filter section has a filter chamber in which a filter is disposed, and the discharge portion is disposed at the uppermost portion of the filter chamber in the vertical direction. In this case, retention of air bubbles in the filter chamber is reduced, so that the obstruction of the flow of liquid by the air bubbles may be suppressed.

In the liquid supply device according to the first aspect, the wall of the filter chamber may also be formed into a tapered shape between the filter and the discharge portion. In this case, the discharging of air bubbles from the discharge portion may be excellently performed.

In the liquid supply device according to the first aspect, the filter may also be disposed to act on the liquid moving upward from the lower side of the vertical direction. In this case, the air bubbles trapped by the filter may be excellently discharged from the filter chamber.

According to a second aspect of the invention, there is provided a liquid ejecting apparatus for ejecting liquid, including: the liquid supply device according to the first aspect; and a head section which ejects liquid supplied from the liquid supply device.

In the liquid ejecting apparatus according to the second aspect, in the filter section, the obstruction of the flow of liquid by air bubbles is suppressed, so that the liquid may be excellently ejected.

In the liquid ejecting apparatus according to the second aspect, the discharge portion may also be disposed such that its height in the vertical direction is equal to or more than that of the introduction portion in two different positions in which the liquid ejecting apparatus can perform the ejecting of the liquid. In this case, in two different positions in which the liquid ejecting apparatus can perform the ejecting of the liquid, the obstruction of the flow of the liquid by air bubbles in the filter section may be suppressed.

In the liquid ejecting apparatus according to the second aspect, the discharge portion may also be disposed at a position corresponding to the uppermost portion of the filter chamber in the vertical direction in the two different positions. In this case, in two different positions in which the liquid ejecting apparatus can perform the ejecting of the liquid, retention of air bubbles in the filter chamber may be reduced.

According to a third aspect of the invention, there is provided a liquid supply device including: a de-foaming chamber for removing air bubbles mixed in liquid; a liquid flow path which supplies the liquid to the de-foaming chamber; a filter section provided in the liquid flow path with an introduction portion for introducing the liquid and a discharge portion for discharging the liquid, where the discharge portion is disposed at a position with a height equal to or more than that of the introduction portion in the vertical direction; and a pressurizing section for supplying the pressurized liquid to the filter section.

In the liquid supply device according to the third aspect, since in the filter section provided in the liquid flow path which supplies the liquid to the de-foaming chamber, the discharge portion is disposed at a position with a height equal to or more than that of the introduction portion and the liquid pressurized by the pressurizing section is introduced, retention of air bubbles in the filter section is suppressed, so that the air bubbles in the liquid may be excellently removed.

In the liquid supply device according to the third aspect, the de-foaming chamber may also be provided with a first filter, through which the liquid passes. In this case, since the air bubbles in the liquid are captured (trapped) by the first filter in the de-foaming chamber, the air bubbles in the liquid may be excellently removed.

In the liquid supply device according to the third aspect, the configuration may also be arranged such that the liquid supply device further includes a depressurized chamber which can have a negative-pressure state, and that the de-foaming chamber has two inner spaces partitioned by the first filter and the upstream side space of the spaces may adjoin the depressurized chamber with a transmission wall having gas permeability interposed therebetween. In this case, the air bubbles in liquid captured (trapped) by the first filter in the de-foaming chamber may be removed by the transmission wall.

In the liquid supply device according to the third aspect, the liquid supply device may further include a sealing valve which is provided in the liquid flow path between the filter section and the de-foaming chamber and can seal the liquid flow path. In this case, since de-foaming by pressurization in the filter section and de-foaming by the reduced-pressure in the de-foaming chamber are carried out by sealing the liquid flow path by the sealing valve, the air bubbles in the liquid may be excellently removed.

In the liquid supply device according to the third aspect, the sealing valve may also adjoin the depressurized chamber. In this case, since the de-foaming chamber can excellently have a reduced-pressure state, the air bubbles in the liquid may be excellently removed.

In the liquid supply device according to the third aspect, the filter section may also be provided with a second filter which is disposed such that the liquid passes upward from the lower side of the vertical direction. In this case, the capturing (trapping) of air bubbles in the liquid by the filter in the filter section may be suppressed.

In the liquid supply device according to the third aspect, the first filter may also be disposed such that the liquid passes downward from the upper side of the vertical direction in the de-foaming chamber. In this case, air bubbles in the liquid can be excellently captured (trapped) by the filter disposed in the de-foaming chamber.

The invention can be realized in various aspects, and, for example, in any liquid ejecting apparatus such as a printer which use a liquid supply device; an image recording apparatus such as a facsimile apparatus; a color material ejecting head used in the manufacturing of color filters for liquid crystal displays or the like; and an electrode material ejecting apparatus used in the forming of the electrodes of an organic EL (Electro Luminescence) display, a field emission display (FED), or the like.

### BRIEF DESCRIPTION OF THE DRAWINGS

The invention will be described with reference to the accompanying drawings, wherein like numbers reference like elements.

FIG. 1 is an explanatory view illustrating the schematic configuration of a printer in a first embodiment of the invention.

FIG. 2 is an explanatory view illustrating the configuration of a filter section according to the first embodiment.

FIG. 3 is an explanatory view illustrating the second position of the filter section.

FIG. 4 is an explanatory view illustrating the flow of ink in the filter section.

FIG. 5 is an explanatory view illustrating the movement of air bubbles in the filter section.

FIG. 6 is an explanatory view illustrating the flow of ink in the filter section in the second position.

FIG. 7 is an explanatory view illustrating the movement of air bubbles in the filter section in the second position.

FIG. 8 is an explanatory view illustrating the schematic configuration of the printer in the first embodiment of the invention.

FIG. 9 is an explanatory view illustrating the configuration of a filter section according to a second embodiment.

FIG. 10 is an explanatory view illustrating a state where a partition portion has been bent.

FIG. 11 is an explanatory view illustrating the configuration of a de-foaming chamber according to the second embodiment.

FIG. 12 is an explanatory view illustrating the flow of ink in the filter section.

FIG. 13 is an explanatory view illustrating the movement of air bubbles in the filter section.

FIG. 14 is an explanatory view illustrating the flow of ink in the de-foaming chamber.

FIG. 15 is an explanatory view illustrating the movement of air bubbles in the de-foaming chamber.

FIG. 16 is an explanatory view illustrating the second position of the filter section.

FIG. 17 is an explanatory view illustrating the second position of the de-foaming chamber.

FIG. 18 is an explanatory view illustrating the schematic configuration of a printer in Modification Example 1.

FIG. 19 is an explanatory view illustrating the schematic configuration of a printer in Modification Example 2.

FIG. 20 is an explanatory view illustrating the configuration of a filter section according to Modification Example 3.

FIG. 21 is an explanatory view illustrating the configuration of a filter section according to Modification Example 4.

FIG. 22 is an explanatory view illustrating the configuration of a filter section according to Modification Example 5.

FIG. 23 is an explanatory view illustrating the configuration of a filter section according to Modification Example 6.

FIG. 24 is an explanatory view illustrating the configuration of a filter section according to Modification Example 7.

FIG. 25 is an explanatory view illustrating the configuration of a filter section according to Modification Example 8.

### DESCRIPTION OF EXEMPLARY EMBODIMENTS

Hereinafter, in order to clarify a liquid supply device according to the invention and a liquid ejecting apparatus using the liquid supply device, a printer which is an aspect of the liquid ejecting apparatus will be explained on the basis of embodiments with reference to the drawings.

### First Embodiment

### Configuration of Printer

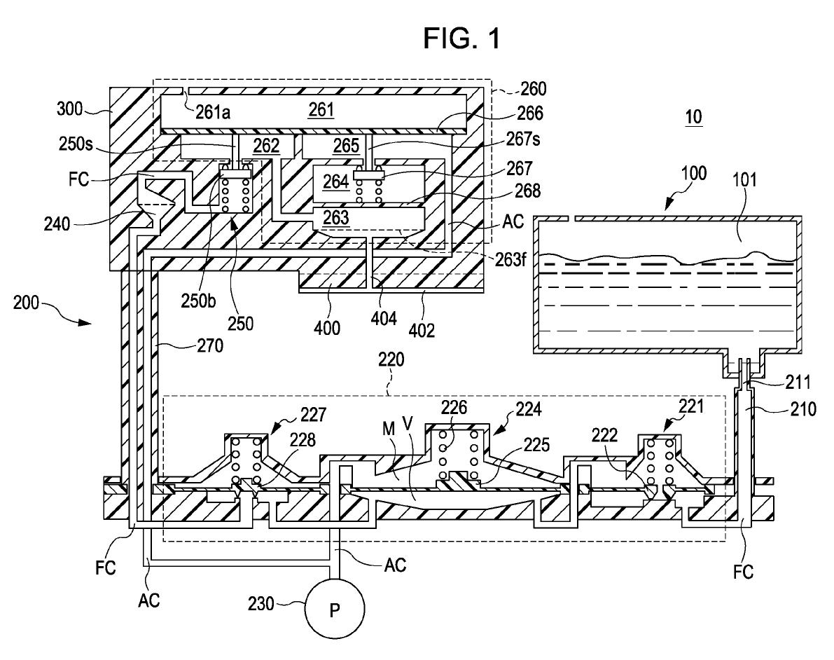

FIG. 1 is an explanatory view illustrating the schematic configuration of the printer 10 in the first embodiment of the invention. The printer 10 used as the liquid ejecting apparatus in the first embodiment is an ink jet type serial printer which can discharge ink of four colors (black, cyan, magenta, and yellow). The printer 10 is provided with an ink cartridge 100, an ink supply device 200, a carriage 300, and a recording head 400.

The ink cartridge 100 is provided with one or a plurality of ink containing portions 101, and each ink containing portion 101 contains ink of each color. In FIG. 1, the ink cartridge 100 having one ink containing portion 101 is shown. However, in the printer 10, one or a plurality of ink cartridges 100 corresponding to the four colors are connected to the ink supply device 200. The printer 10 is of a so-called off-carriage type in which the ink cartridge 100 is mounted on the main body side of the printer. The ink cartridge 100 is mounted on the main body frame (not shown) of the printer 10 by a cartridge holder (not shown).

The ink supply device 200 supplies ink contained in the ink cartridge 100 to the recording head 400. The ink supply device 200 includes a cartridge connection portion 210, a flow path pump section 220, a depressurizing pump portion 230, a filter section 240, a valve unit 250, a reduced-pressure de-foaming section 260, and a tube 270. The ink supply device 200 is disposed for each of the four colors. Since the ink supply devices 200 have the same configuration for all colors, FIG. 1 shows only one ink supply device 200 which supplies ink of any one color.

The cartridge connection portion 210 connects the ink supply device 200 to the ink cartridge 100. The cartridge connection portion 210 has a hollow needle 211, and when the hollow needle 211 is inserted into the ink cartridge 100, the ink containing portion 101 of the ink cartridge 100 is communicated with an ink flow path FC in the ink supply device 200.

The flow path pump section 220 sucks in ink from the ink cartridge 100 and pressure-feeds it to the carriage 300. The flow path pump section 220 includes a suction side check valve 221, a pump 224, and a discharge side check valve 227. The suction side check valve 221, the pump 224, and the discharge side check valve 227 are disposed in the ink flow path FC in the order of the suction side check valve 221, the pump 224, and the discharge side check valve 227 from the upstream ink cartridge 100 side.

The suction side check valve 221 is formed to be able to open or close the ink flow path FC by a suction side valve body 222 and functions as a one-way valve which allows only the movement of ink from the ink cartridge 100 side to the pump 224 side. The discharge side check valve 227 is formed to be able to open or close the ink flow path FC by a discharge side valve body 228 and functions as a one-way valve which allows only the movement of ink from the pump 224 side to the recording head 400 side.

The pump 224 includes a diaphragm 225 and a spring 226 and pressure-feeds ink in the ink cartridge 100 to the carriage 300. Specifically, if an upper space region M of the diaphragm 225 is in a negative-pressure state by the depressurizing pump portion 230, which will be described later, the diaphragm 225 is bent upward, so that the volume of a variable volume space region V formed in the ink flow path FC is increased. When the volume of the space region V is increased, the pump 224 allows ink to flow from the cartridge 100 into the space region V through the suction side check valve 221. Also, if the negative-pressure state of the upper space region M is removed by the depressurizing pump portion 230, the pump 224 reduces the volume of the space region V due to the depression of the diaphragm 225 by the spring 226. At this time, the ink contained in the space region V is pressure-fed to the recording head 400 side by the biasing force of the spring 226.

The depressurizing pump portion 230 generates a negative pressure, so that the upper space region M of the pump 224 and a negative-pressure chamber 265 of the reduced-pressure de-foaming section 260 described later, which are communicated with each other through an air flow path AC, have a negative-pressure state. Also, the depressurizing pump portion 230 has a valve body (not shown), and when the air flow path AC is opened to the outside by the opening of the valve body, the negative-pressure states of the upper space region M and the negative-pressure chamber 265 are removed.

The filter section 240 is disposed in the ink flow path FC between the flow path pump section 220 and the recording head 400 so as to filter ink sent from the flow path pump section 220 to the recording head 400, thereby capturing (trapping) impurities (dust, grit, etc.). The filter section 240 is one of the features of the invention and the shape and configuration thereof will be described later.

The valve unit 250 is disposed in the ink flow path FC between the filter section 240 and the recording head 400 and formed to be able to open or close the ink flow path FC by a valve body 250b. When the valve body 250b is at an open position, ink can flow from the filter section 240 to the recording head 400 side. Also, when the valve body 250b is at a sealing position, ink cannot flow from the filter section 240 to the recording head 400 side.

The reduced-pressure de-foaming section 260 is disposed in the ink flow path FC between the valve unit 250 and the recording head 400 so as to perform the removal of air bubbles mixed in ink. The reduced-pressure de-foaming section 260 includes an air chamber 261, a pressure chamber 262, a de-foaming chamber 263, a depressurized chamber 264, and the negative-pressure chamber 265.

The air chamber 261 is communicated with the outside through an air communication hole 261a. The pressure chamber 262 can temporarily collect ink and adjoins the air chamber 261 at a ceiling portion with a partition portion 266 interposed therebetween. The partition portion 266 is configured by a film made of a flexible member, and a cantilevered thin plate member displaceable along with the film. The pressure chamber 262 is communicated with the valve unit 250 and the de-foaming chamber 263. A rod portion 250s of the valve body 250b in the valve unit 250 is joined to the partition portion 266 inside the pressure chamber 262, so that the valve body 250b is displaced between the open position and the sealing position by the upward and downward displacement of the partition portion 266. When the valve body 250b is at the open position, ink flows into the pressure chamber 262 through the valve unit 250.

The de-foaming chamber 263 is a hollow chamber having a filter 263f inside thereof and is communicated with the pressure chamber 262 and the recording head 400. The de-foaming chamber 263 is used to temporarily store ink flowing in from the pressure chamber 262 and remove air bubbles in ink by a de-foaming action. The ink stored in the de-foaming chamber 263 passes through the filter 263f and is discharged to the recording head 400. The filter 263f filters ink to remove the impurities (dust, grit, etc.), and also has a function of making it difficult for the air bubbles mixed in the ink flow path FC to pass through the filter and capturing (trapping) air bubbles at the ceiling portion of the de-foaming chamber 263. Further, the ink discharged from the de-foaming chamber 263 passes through an ink discharging tube 404 connected to the lower surface of the de-foaming chamber 263 and is discharged out of a plurality of nozzles (not shown) provided in a nozzle plate 402.

The depressurized chamber 264 is disposed above the de-foaming chamber 263 with a partition portion 268 interposed therebetween. The partition portion 268 is made of a synthetic resin material having gas permeability. As the gas permeable member, for example, polyacetal, polypropylene, polyphenylene ether, or the like can be adopted. The depressurized chamber 264 is communicated with the negative-pressure chamber 265 through a flow path valve 267.

The negative-pressure chamber 265 is a hollow chamber communicated with the depressurizing pump portion 230 through the air flow path AC and adjoins the air chamber 261 at a ceiling portion with the partition portion 266 interposed therebetween, similarly to the pressure chamber 262. A rod portion 267s of the flow path valve 267 is joined to the partition portion 266 inside the negative-pressure chamber 265, so that the flow path valve 267 is displaced between the open position and the sealing position by the upward and downward displacement of the partition portion 266. If the negative-pressure chamber 265 is in a negative-pressure due to the driving of the depressurizing pump portion 230, the partition portion 266 is bent and deformed to the negative-pressure chamber 265 side due to a differential pressure between the negative-pressure chamber 265 and the air chamber 261. According to this, the flow path valve 267 is moved to the open position, so that the negative-pressure in the negative-pressure chamber 265 is introduced into the depressurized chamber 264. On the other hand, if the negative-pressure chamber 265 is opened to the outside due to the driving of the depressurizing pump portion 230, the flow path valve 267 is displaced to the sealing position by the biasing force of a spring, so that the depressurized chamber 264 is maintained in a negative-pressure state. When the depressurized chamber 264 is maintained in a negative-pressure state, the air bubbles or the dissolved air in the ink stored in the de-foaming chamber 263 permeates the partition portion 268, and then is collected into the depressurized chamber 264. Therefore, the de-foaming of ink is performed by the reduced-pressure de-foaming section 260.

The carriage 300 is disposed so as to be able to reciprocate in a main scanning direction along a guide rod (not shown) by the power of a carriage motor (not shown). In the carriage 300, the filter section 240, the valve unit 250, and the reduced-pressure de-foaming section 260 of the ink supply device 200 are mounted. The tube 270 is disposed between the flow path pump section 220 and the filter section 240, so that even during the movement of the carriage 300, the supply of ink from the flow path pump section 220 to the filter section 240 or the decompression of the negative-pressure chamber 265 by the depressurizing pump portion 230 is possible. Although in this embodiment, the printer 10 is described as being an off-carriage type, a so-called on-carriage type in which the ink cartridge 100 is mounted on the carriage 300 is also appropriate.

The recording head 400 is disposed on the lower surface of the carriage 300 and discharges ink droplets from a plurality of nozzles (not shown) on a recording medium with the reciprocating motion of the carriage 300 in the main scanning direction. At this time, the recording medium is fed in a secondary scanning direction by a paper feed mechanism (not shown), so that an image, etc. are formed on the recording medium.

### Configuration of Filter Section

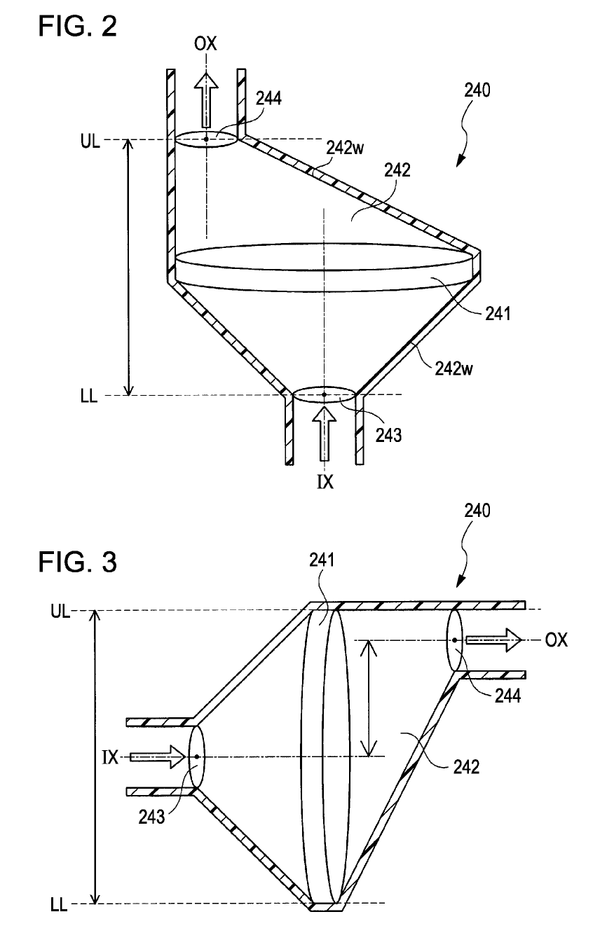

FIG. 2 is an explanatory view illustrating the configuration of the filter section according to the first embodiment. The filter section 240 includes a filter 241, a filter chamber 242, an introduction port 243, and a discharge port 244. The filter chamber 242 is a hollow chamber, and in the vicinity of the center of the filter chamber, the filter 241 of an approximately plate-shape is disposed in an approximately horizontal direction. In this embodiment, the highest position of the filter chamber 242 in the vertical direction is called an uppermost portion UL and the lowest position in the vertical direction is called a lowermost portion LL. The introduction port 243 is disposed at the lowermost portion LL of the filter chamber 242 and introduces ink pressure-fed from the flow path pump section 220 into the filter chamber 242. The discharge port is disposed at the uppermost portion UL of the filter chamber 242 and discharges ink in the filter chamber 242 to the valve unit 250.

The discharge port 244 and the introduction port are disposed such that an axis OX of the discharge port and an axis IX of the introduction port 243 have each a direction along the vertical direction. The discharge port 244 is disposed such that the axis OX of the discharge port 244 is out of alignment with the axis IX of the introduction port 243 and is biased so as to follow the end of one side (left side in FIG. 2) in the horizontal direction of the filter chamber 242. The introduction port 243 is disposed such that the axis IX of the introduction port 243 intersects the filter 241. That is, the filter 241 is disposed on the introduction direction of ink from the introduction port 243 to the filter chamber 242. A side 242w of the filter chamber 242 is formed into a tapered shape not only between the filter 241 and the introduction port 243, but also between the filter 241 and the discharge port 244.

The printer 10 in this embodiment can be used in two different positions such as a lengthwise-mounted posture and a transverse-mounted posture. That is, the printer 10 can perform printing not only in the above-described first position shown in FIG. 2, but also in the second position turned by the angle of 90 degrees rightward from the first position.

FIG. 3 is an explanatory view illustrating the second position of the filter section. In the first position, the filter section 240 is disposed such that the axis OX is out of alignment with the axis IX, and therefore also in the second position, the discharge port 244 is in a state where it is disposed at a higher position than the position of the introduction port 243 in the vertical direction. Further, in the first position, the discharge port 244 is disposed biased so as to follow the end of one side in the horizontal direction of the filter chamber 242, and therefore also in the second position, the discharge port 244 is in a state where it is disposed in contact with the uppermost portion UL of the filter chamber 242.

### Air Bubbles Removal in Filter Section

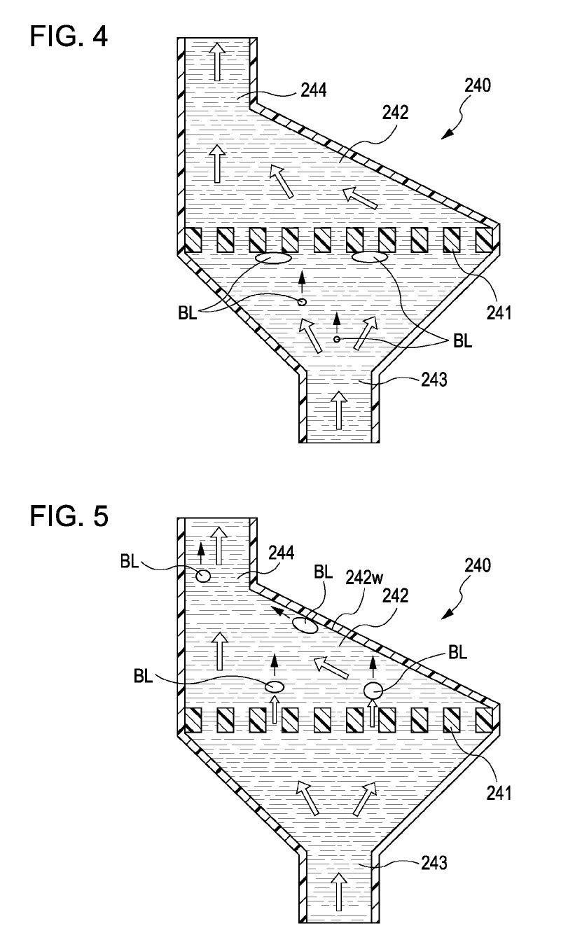

A state where the air bubbles in ink are removed from the filter section 240 in the first position is explained. FIG. 4 is an explanatory view illustrating the flow of ink in the filter section and FIG. 5 is an explanatory view illustrating the movement of air bubbles in the filter section. The ink flowing into the filter chamber 242 through the introduction port 243 due to the pressure-feeding of ink by the flow path pump section 220 moves upward from the lower side of the vertical direction. Since the filter 241 is disposed in an approximately horizontal direction, the filter acts on ink moving upward from the lower side of the direction of gravity. That is, the filter 241 can filter ink moving upward from the lower side of the direction of gravity. In this embodiment, the filter 241 is disposed in an approximately horizontal direction. However, even if the filter 241 is disposed at a given angle with respect to the horizontal direction, the filter can act on ink moving upward from the lower side of the direction of gravity. The filtered ink is discharged out of the discharge port 244 disposed on the upper side of the vertical direction.

When ink is filtered by the filter 241, some of the air bubbles BL mixed in ink are captured (trapped) by the filter 241, as shown in FIG. 4. However, since the flow path pump section 220 pressure-feeds ink such that the upward force applied to the air bubbles BL due to the pressure-feeding of ink is higher than the resisting force of the captured air bubbles BL, the air bubbles BL captured by the filter 241 are not retained at the filter 241, but are separated from the filter 241, and then move upward by the flow force of ink and buoyancy, as shown in FIG. 5. Further, since the side 242w of the filter chamber 242 is formed into a tapered shape, the air bubbles BL are discharged out of the discharge port 244 along the tapered side 242w.

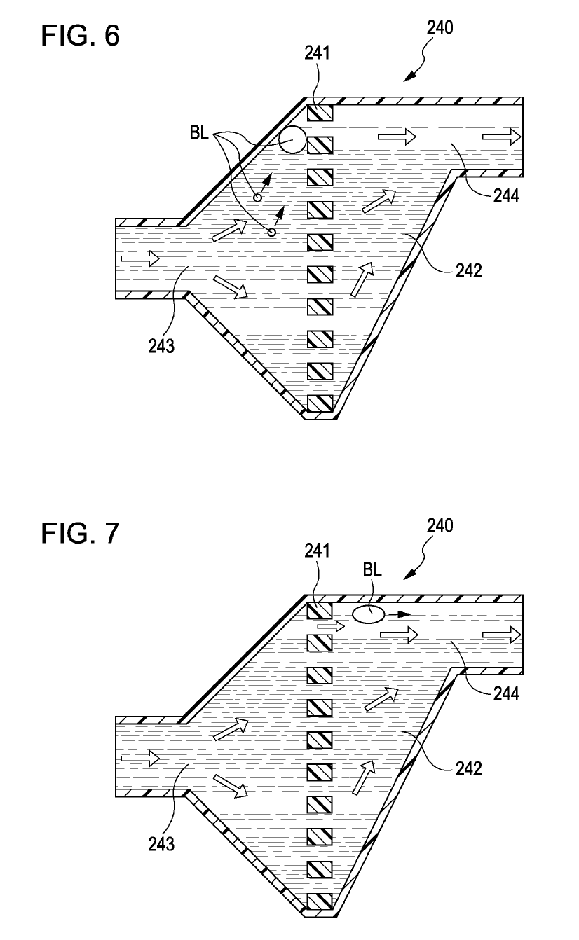

FIG. 6 is an explanatory view illustrating the flow of ink in the filter section of the second position, and FIG. 7 is an explanatory view illustrating the movement of air bubbles in the filter section of the second position. Also in the second position, similarly to the first position, ink flowing into the filter chamber 242 through the introduction port 243 due to the pressure-feeding of ink by the flow path pump section 220 moves to the discharge port 244 side (the right upward direction in FIG. 6), passes through the filter 241, thereby being filtered, and then is discharged out of the discharge port 244. When ink is filtered by the filter 241, some of the air bubbles BL mixed in ink are captured (trapped) at the upper portion on the introduction port 243 side of the filter 241, as shown in FIG. 6. However, since the flow path pump section 220 pressure-feeds ink such that the force applied to the air bubbles BL due to the pressure-feeding of ink is higher than the resisting force of the captured air bubbles BL, the air bubbles BL captured by the filter 241 are not retained at the introduction port 243 side of the filter 241, but pass through the filter 241, and then move to the discharge port 244 side, as shown in FIG. 7. The air bubbles BL moved to the discharge port 244 side are discharged out of the discharge port 244 by the flow force of ink and buoyancy.

In the ink supply device 200 according to the first embodiment described above, since in the filter section 240, the discharge port 244 is disposed at a position with a height equal to or more than that of the introduction port 243 in the vertical direction and ink pressurized by the flow path pump section 220 is supplied, the obstruction of the flowing of ink by the air bubbles BL can be suppressed. Specifically, since the discharge port 244 is disposed at a position with a height equal to or more than that of the introduction port 243 in the vertical direction, a state is suppressed in which the air bubbles BL passed through the filter 241 move to the filter 241 side due to buoyancy, thereby again being captured (trapped) by the filter 241, and the air bubbles BL can move to the discharge port 244. Further, since ink is supplied pressurized by the flow path pump section 220, the force pushing out the air bubbles BL to the discharge port 244 side is added, thereby making it difficult for the air bubbles to be trapped by the filter 241. Further, even if the air bubbles are temporarily trapped, they can be separated later.

In the ink supply device 200 according to the first embodiment described above, since the discharge port 244 is disposed at the uppermost portion UL of the filter chamber 242, retention of the air bubbles BL in the filter chamber 242 is reduced, so that the obstruction of the flowing of ink by the air bubbles BL can be suppressed. Specifically, even if the air bubbles BL move upward due to buoyancy, so that they stay in the vicinity of the uppermost portion UL of the filter chamber 242, since the discharge port 244 is disposed at the uppermost portion UL, the air bubbles BL can easily move to the discharge port 244 without being resisted due to buoyancy, whereby retention of the air bubbles at the uppermost portion UL can be suppressed.

In the ink supply device 200 according to the first embodiment described above, since the side 242w of the filter chamber 242 is formed into a tapered shape between the filter 241 and the discharge port 244, the air bubbles BL can move to the discharge port 244 along the side 242w, so that they can be excellently discharged out of the discharge port 244.

In the ink supply device 200 according to the first embodiment described above, since the filter 241 is horizontally disposed so as to act on ink which moves upward from the lower side of the vertical direction, the air bubbles BL can be excellently discharged from the filter chamber 242 by the flow force of ink which is pressurized and introduced by the flow path pump section 220.

In the printer 10 according to the first embodiment described above, in two different positions in which the printer 10 can perform printing, the discharge port 244 is disposed at a position with a height equal to or more than that of the introduction port 243 in the vertical direction, and therefore the obstruction of the flowing of ink by the air bubbles BL in the filter section 240 in the two different positions can be suppressed.

In the printer 10 according to the first embodiment described above, in two different positions in which the printer 10 can perform printing, the discharge port 244 is disposed at the uppermost portion UL of the filter chamber 242, and therefore retention of the air bubbles BL in the filter chamber 242 in the two different positions is reduced, so that the obstruction of the flowing of ink by the air bubbles BL in the filter section 240 can be suppressed.

### Second Embodiment

### Configuration of Printer

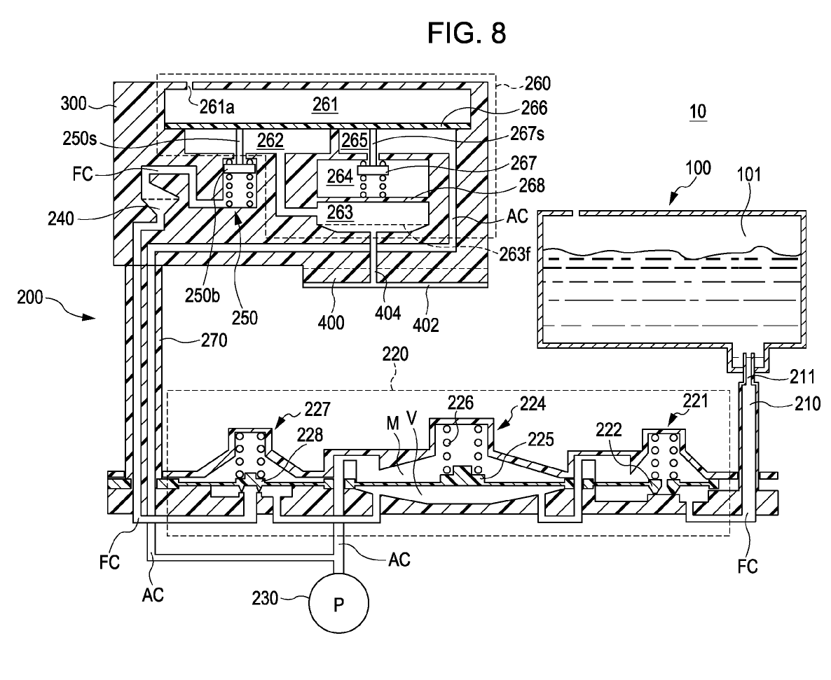

FIG. 8 is an explanatory view illustrating the schematic configuration of the printer 10 in the first embodiment of the invention. The printer 10 used as the liquid ejecting apparatus in the first embodiment is an ink jet type serial printer which can discharge ink of four colors (black, cyan, magenta, and yellow). The printer 10 includes the ink cartridge 100, the ink supply device 200, the carriage 300, and the recording head 400.

The ink cartridge 100 is provided with one or a plurality of ink containing portions 101, and each ink containing portion 101 contains ink of each color. Although in FIG. 8, the ink cartridge 100 having one ink containing portion 101 is shown, in the printer 10, one or a plurality of ink cartridges 100 corresponding to the four colors are connected to the ink supply device 200. The printer 10 is of a so-called off-carriage type in which the ink cartridge 100 is mounted on the main body side of the printer. The ink cartridge 100 is mounted on the main body frame (not shown) of the printer 10 by the cartridge holder (not shown).

The ink supply device 200 supplies ink contained in the ink cartridge 100 to the recording head 400. The ink supply device 200 includes the cartridge connection portion 210, the flow path pump section 220, the depressurizing pump portion 230, the filter section 240, the valve unit 250, the reduced-pressure de-foaming section 260, and the tube 270. The ink supply device 200 is disposed for each of the four colors. Since the ink supply devices 200 have the same configuration for all colors, FIG. 8 shows only one ink supply device 200 which supplies ink of any one color.

The cartridge connection portion 210 connects the ink supply device 200 to the ink cartridge 100. The cartridge connection portion 210 has the hollow needle 211, and when the hollow needle 211 is inserted into the ink cartridge 100, the ink containing portion 101 of the ink cartridge 100 is communicated with the ink flow path FC in the ink supply device 200.

The flow path pump section 220 sucks in ink from the ink cartridge 100 and pressure-feeds it to the carriage 300. The flow path pump section 220 includes the suction side check valve 221, the pump 224, and the discharge side check valve 227. The suction side check valve 221, the pump 224, and the discharge side check valve 227 are disposed in the flow path FC in the order of the suction side check valve 221, the pump 224, and the discharge side check valve 227 from the upstream ink cartridge 100 side.

The suction side check valve 221 is formed to be able to open or close the ink flow path FC by the suction side valve body 222 and functions as a one-way valve which allows only the movement of ink from the ink cartridge 100 side to the pump 224 side. The discharge side check valve 227 is formed to be able to open or close the ink flow path FC by the discharge side valve body 228 and functions as a one-way valve which allows only the movement of ink from the pump 224 side to the recording head 400 side.

The pump 224 includes the diaphragm 225 and the spring 226 and pressure-feeds ink in the ink cartridge 100 to the carriage 300. Specifically, when the upper space region M of the diaphragm 225 is in a negative-pressure state by the depressurizing pump portion 230, which will be described later, the diaphragm 225 is bent upward, so that the volume of the variable volume space region V formed in the ink flow path FC is increased. When the volume of the space region V is increased, the pump 224 allows ink to flow from the ink cartridge 100 into the space region V through the suction side check valve 221. Also, if the negative-pressure state of the upper space region M is removed by the depressurizing pump portion 230, the pump 224 reduces the volume of the space region V due to the depression of the diaphragm 225 by the spring 226. At this time, the ink contained in the space region V is pressure-fed to the recording head 400 side by the biasing force of the spring 226.

The depressurizing pump portion 230 generates a negative pressure, so that the upper space region M of the pump 224 and the negative-pressure chamber 265 of the reduced-pressure de-foaming section 260 described later, which are communicated with each other through the air flow path AC, have a negative-pressure state. Also, the depressurizing pump portion 230 has a valve body (not shown) and when the air flow path AC is opened to the outside by the opening of the valve body, the negative-pressure states of the upper space region M and the negative-pressure chamber 265 are removed.

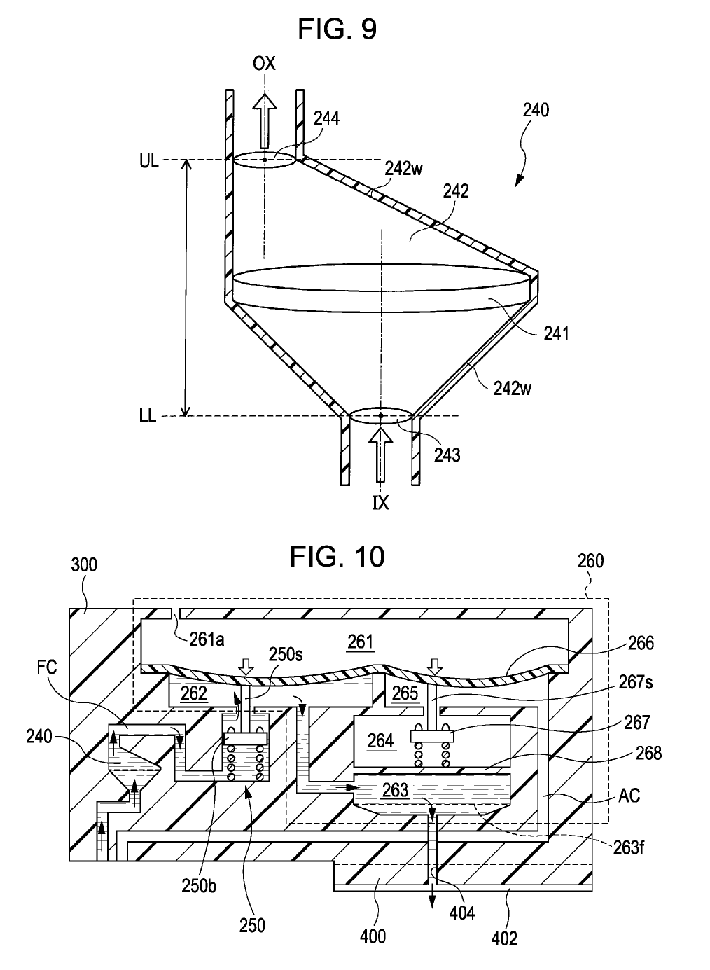

FIG. 9 is an explanatory view illustrating the configuration of the filter section according to the second embodiment. The filter section 240 is disposed in the ink flow path FC between the flow path pump section 220 and the recording head 400 so as to filter the ink which is sent from the flow path pump section 220 to the recording head 400, thereby capturing (trapping) impurities (dust, grit, etc.). The filter section 240 includes the filter 241, the filter chamber 242, the introduction port 243, and the discharge port 244. The filter chamber 242 is a hollow chamber, and in the vicinity of the center of the filter chamber, the filter 241 of an approximately plate-shape is disposed in an approximately horizontal direction. In this embodiment, the highest position of the filter chamber 242 in the vertical direction is called the uppermost portion UL and the lowest position in the vertical direction is called the lowermost portion LL. The introduction port 243 is disposed at the lowermost portion LL of the filter chamber 242 and introduces ink pressure-fed from the flow path pump section 220 into the filter chamber 242. The discharge port 244 is disposed at the uppermost portion UL of the filter chamber 242 and discharges ink in the filter chamber 242 to the valve unit 250.

The discharge port 244 and the introduction port 243 are disposed such that the axis OX of the discharge port 244 and the axis IX of the introduction port 243 have each a direction along the vertical direction. The discharge port is disposed such that the axis OX of the discharge port is out of alignment with the axis IX of the introduction port 243 and is biased so as to follow the end of one side (left side in FIG. 9) of the filter chamber 242 in the horizontal direction. The introduction port 243 is disposed such that the axis IX of the introduction port 243 intersects the filter 241. That is, the filter 241 is disposed on the introduction direction of ink from the introduction port 243 to the filter chamber 242. The side 242w of the filter chamber 242 is formed into a tapered shape not only between the filter 241 and the introduction port 243, but also between the filter 241 and the discharge port 244.

The valve unit 250 is disposed in the ink flow path FC between the filter section 240 and the recording head 400, as shown FIG. 8, and adjacent to the depressurized chamber described later. The valve unit 250 is formed to be able to open or close the ink flow path FC by the valve body 250b. When the valve body 250b is at the open position, ink can flow from the filter section 240 to the recording head 400 side. Also, when the valve body 250b is at the sealing position, ink cannot flow from the filter section 240 to the recording head 400 side. When the valve body 250b is at the sealing position, ink between the valve unit 250 and the flow path pump section 220 can be maintained as pressurized by pressurizing the ink by the flow path pump section 220. Also, the de-foaming chamber 263 of the reduced-pressure de-foaming section 260 described later can be in a sealed state due to the driving of the depressurizing pump portion 230. The valve unit 250 corresponds to a “sealing valve” in the claims.

The reduced-pressure de-foaming section 260 is disposed in the ink flow path FC between the valve unit 250 and the recording head 400 so as to perform the removal of the air bubbles mixed in ink. The reduced-pressure de-foaming section 260 is provided with the air chamber 261, the pressure chamber 262, the de-foaming chamber 263, the depressurized chamber 264, and the negative-pressure chamber 265.

The air chamber 261 is communicated with the outside through the air communicating hole 261a. The pressure chamber 262 can temporarily collect ink and adjoins the air chamber 261 at a ceiling portion with the partition portion 266 interposed therebetween. The partition portion 266 is configured by a film made of a flexible member, and a cantilevered thin plate member displaceable along with the film. The pressure chamber 262 is communicated with the valve unit 250 and the de-foaming chamber 263.

FIG. 10 is an explanatory view illustrating a state where the partition portion has been bent. The rod portion 250s of the valve body 250b in the valve unit 250 is joined to the partition portion 266 inside the pressure chamber 262, so that the valve body 250b is displaced between the open position and the sealing position by the upward and downward displacement of the partition portion 266. If ink in the pressure chamber 262 is reduced, the partition portion 266 is downward bent, as shown in FIG. 10, so that the valve body 250b is pushed down, and when the valve body 250b is at the open position, ink flows into the pressure chamber 262 through the valve unit 250.

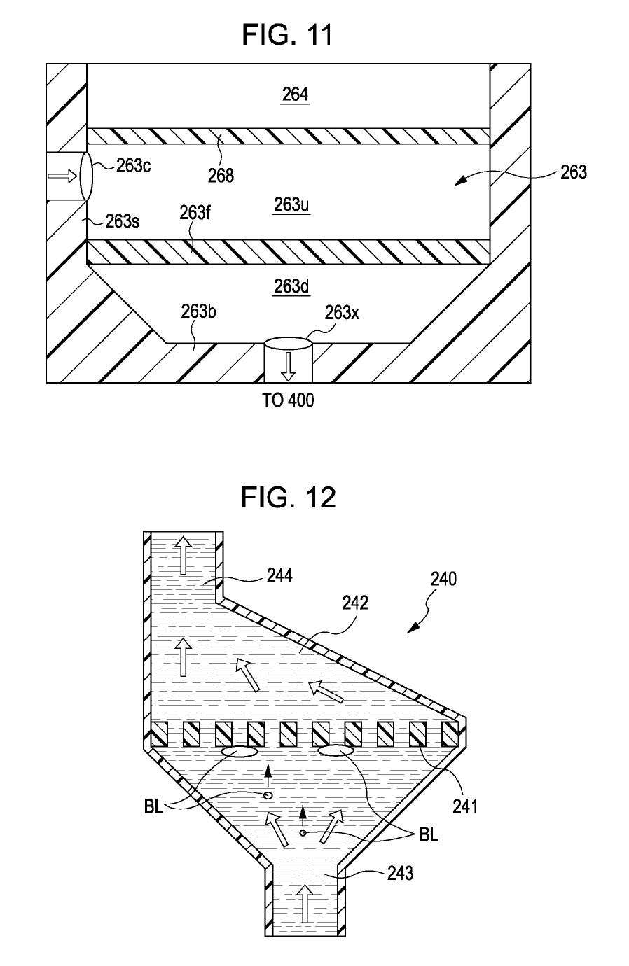

FIG. 11 is an explanatory view illustrating the configuration of the de-foaming chamber according to the second embodiment. The de-foaming chamber 263 is used to temporarily store ink and remove air bubbles in ink by a de-foaming action. The de-foaming chamber 263 has a de-foaming chamber introduction port 263c, a de-foaming chamber discharge port 263x, and a filter 263f. The de-foaming chamber introduction port 263c is disposed at a side 263s of the de-foaming chamber 263 and is communicated with the pressure chamber 262. The de-foaming chamber discharge port 263x is disposed at a bottom 263b of the de-foaming chamber 263 and is communicated with the recording head 400. Therefore, the de-foaming chamber introduction port 263c is disposed at a higher position than the de-foaming chamber discharge port 263x in the vertical direction. The filter 263f has an approximately plate-shape, is disposed in an approximately horizontal direction between the de-foaming chamber introduction port 263c and the de-foaming chamber discharge port 263x, and filters ink so as to remove impurities (dust, grit, etc.). The de-foaming chamber 263 is partitioned by the filter 263f to define two spaces, an upper space 263u and a lower space 263d. The de-foaming chamber 263 has the partition portion 268 made of a synthetic resin material having gas permeability, which is provided at the ceiling portion of the upper space 263u having the de-foaming chamber introduction port 263c. As the partition portion 268, for example, polyacetal, polypropylene, polyphenylene ether, or the like can be adopted. The partition portion 268 corresponds to a “transmission wall” in the claims. The ink introduced from the de-foaming chamber introduction port 263c is discharged from the de-foaming chamber discharge port 263x through the filter 263f after the removal of the air bubbles in the ink through the partition portion 268. Further, the ink discharged from the de-foaming chamber 263 passes through the ink discharging tube 404, and then is discharged out of a plurality of nozzles (not shown) provided in the nozzle plate 402.

The depressurized chamber 264 is disposed above the de-foaming chamber 263 with the partition portion 268 interposed therebetween, as shown FIG. 8, and is communicated with the negative-pressure chamber 265 with the flow path valve 267 interposed therebetween. Further, the depressurized chamber 264 is disposed at the position adjacent to the pressure chamber 262, whereby the volumes of the pressure chamber 262 and the de-foaming chamber 263 are suppressed.

The negative-pressure chamber 265 is communicated with the depressurizing pump portion 230 through the air flow path AC and adjoins the air chamber 261 at the ceiling portion with the partition portion 266 interposed therebetween, similarly to the pressure chamber 262. The rod portion 267s of the flow path valve 267 is joined to the partition portion 266 inside the negative-pressure chamber 265, so that the flow path valve 267 is displaced between the open position and the sealing position by the upward and downward displacement of the partition portion 266. If the negative-pressure chamber 265 is in a negative-pressure due to the driving of the depressurizing pump portion 230, the partition portion 266 is bent and deformed to the negative-pressure chamber 265 side due to a differential pressure between the negative-pressure chamber 265 and the air chamber 261, as shown in FIG. 10. According to this, the flow path valve 267 is moved to the open position, so that the negative-pressure in the negative-pressure chamber 265 is introduced into the depressurized chamber 264. On the other hand, if the negative-pressure chamber 265 is opened to the outside due to the driving of the depressurizing pump portion 230, the flow path valve 267 is displaced to the sealing position by the biasing force of the spring, so that the depressurized chamber 264 is maintained in a negative-pressure state. When the depressurized chamber 264 is maintained in a negative-pressure state, the air bubbles or the dissolved air in ink stored in the de-foaming chamber 263 permeates the partition portion 268, and then is collected into the depressurized chamber 264. Therefore, the de-foaming of ink is performed by the reduced-pressure de-foaming section 260.

The carriage 300 is disposed so as to be able to reciprocate in the main scanning direction along a guide rod (not shown) by the power of a carriage motor (not shown). In the carriage 300, the filter section 240, the valve unit 250, and the reduced-pressure de-foaming section 260 of the ink supply device 200 are mounted. The tube 270 is disposed between the flow path pump section 220 and the filter section 240, so that even during the movement of the carriage 300, the supply of ink from the flow path pump section 220 to the filter section 240 or the decompression of the negative-pressure chamber 265 by the depressurizing pump portion 230 is possible. Although in this embodiment, the printer 10 is described as being an off-carriage type, a so-called on-carriage type in which the ink cartridge 100 is mounted on the carriage 300 is also appropriate.

The recording head 400 is disposed on the lower surface of the carriage 300 and discharges ink droplets from a plurality of nozzles (not shown) on a recording medium with the reciprocating motion of the carriage 300 in the main scanning direction. At this time, the recording medium is fed in the secondary scanning direction by a paper feed mechanism (not shown), so that an image, etc. are formed on the recording medium.

### Air Bubbles Removal in Filter Section

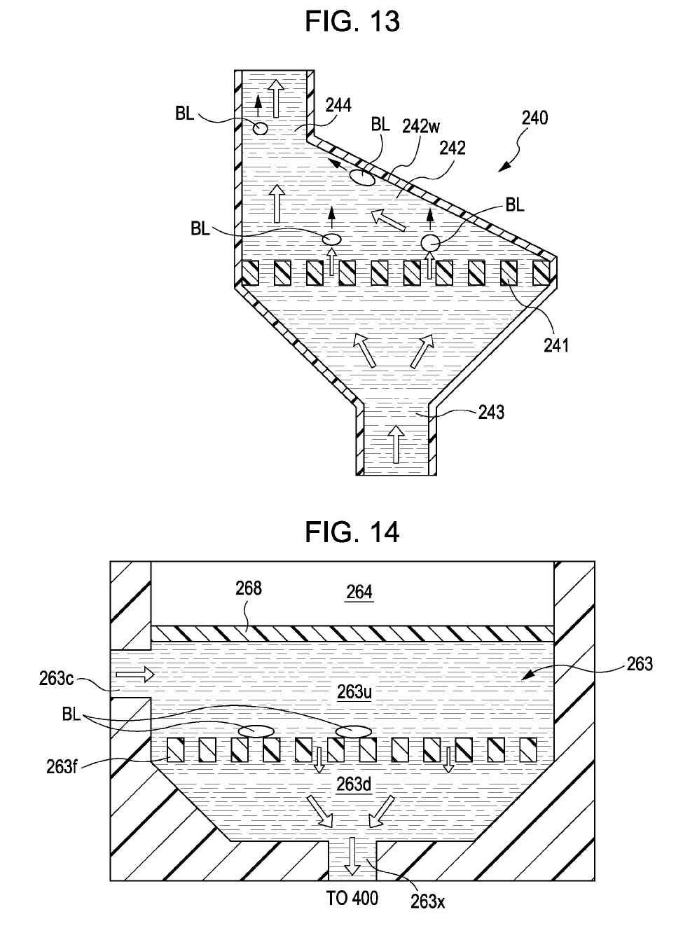

A state where air bubbles in ink are removed from the filter section 240 is explained. FIG. 12 is an explanatory view illustrating the flow of ink in the filter section and FIG. 13 is an explanatory view illustrating the movement of air bubbles in the filter section. The ink flowing into the filter chamber 242 through the introduction port 243 due to the pressure-feeding of ink by the flow path pump section 220 moves upward from the lower side of the vertical direction, passes through the filter 241, thereby being filtered, and then is discharged out of the discharge port 244. When ink is filtered by the filter 241, some of the air bubbles BL mixed in ink are captured (trapped) by the filter 241, as shown in FIG. 12. However, since the flow path pump section 220 pressure-feeds ink such that the upward force applied to the air bubbles BL due to the pressure-feeding of ink is higher than the resisting force of the captured air bubbles BL, the air bubbles BL captured by the filter 241 are not retained at the filter 241, are separated from the filter 241, and then move upward by the flow force of ink and buoyancy, as shown in FIG. 13. Further, since the side 242w of the filter chamber 242 is formed into a tapered shape, the air bubbles BL are discharged out of the discharge port 244 along the tapered side 242w. The air bubbles BL discharged from the discharge port 244 pass through the ink flow path FC along with ink and move to the de-foaming chamber 263.

### Air Bubbles Removal in De-foaming Chamber

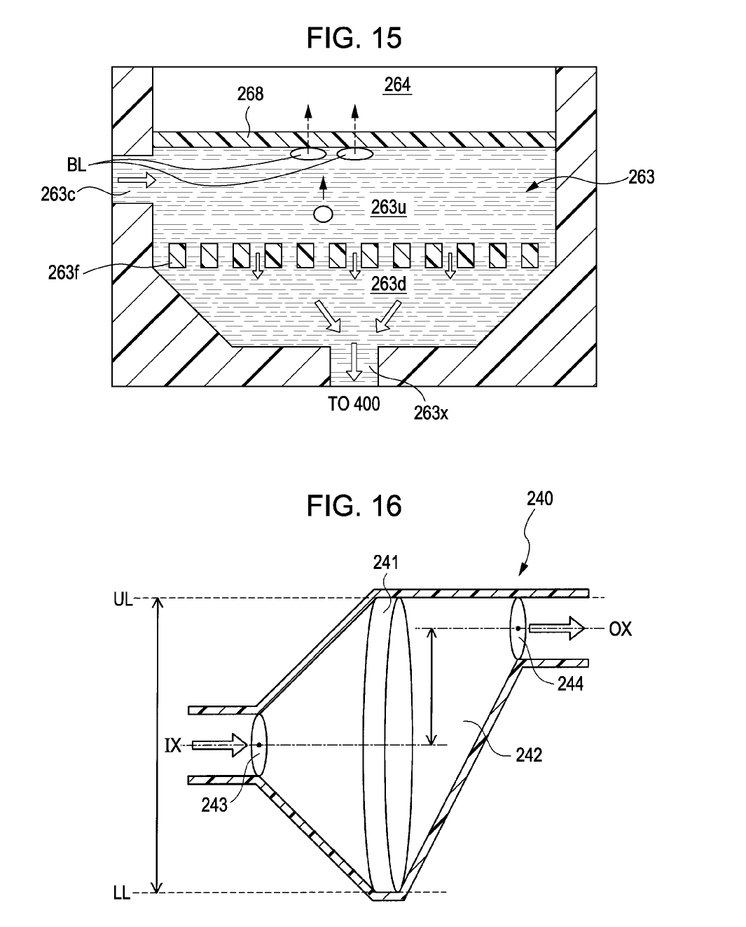

A state where the air bubbles in ink in the de-foaming chamber 263 are removed is explained. FIG. 14 is an explanatory view illustrating the flow of ink in the de-foaming chamber and FIG. 15 is an explanatory view illustrating the movement of air bubbles in the de-foaming chamber. The ink flowing into the de-foaming chamber through the de-foaming chamber introduction port 263c is temporarily stored in the de-foaming chamber 263. As ink is discharged from the recording head 400, ink in the de-foaming chamber 263 is sucked out from the de-foaming chamber discharge port 263x. As ink in the de-foaming chamber 263 is sucked out from the de-foaming chamber discharge port 263x, the ink moves downward from the upper side of the vertical direction and passes through the filter 263f, thereby being filtered. When the ink is filtered by the filter 263f, some of the air bubbles BL mixed in ink are captured (trapped) by the filter 241 in the upper space 263u, as shown in FIG. 14. The captured air bubbles move to the upper side of the vertical direction due to buoyancy and stay in the vicinity of the partition portion 268 disposed at the ceiling portion of the upper space 263u, as shown in FIG. 15. If the depressurized chamber 264 is in a negative-pressure state, the gas constituting the air bubbles BL move to the depressurized chamber 264 side through the partition portion 268 having gas permeability due to a differential pressure, so that the air bubbles BL can be removed from the ink in the de-foaming chamber 263.

In the ink supply device 200 according to the second embodiment described above, in the filter section 240, the discharge port 244 is disposed at a position with a height equal to or more than that of the introduction port 243 in the vertical direction and the ink pressurized by the flow path pump section 220 is supplied, and therefore the air bubbles BL in ink can be excellently removed. Specifically, since the discharge port 244 is disposed at a position with a height equal to or more than that of the introduction port 243 in the vertical direction, a state is suppressed in which the air bubbles BL passed through the filter 241 move upward due to buoyancy, thereby again being captured (trapped) by the filter 241, and the air bubbles BL can move to the discharge port 244. Further, since ink is supplied pressurized by the flow path pump section 220, the force pushing out the air bubbles BL to the discharge port 244 side is added, thereby making it difficult for the air bubbles to be trapped by the filter 241. Further, even if the air bubbles are temporarily trapped, they can be separated later.

In the ink supply device 200 according to the second embodiment, since retention of the air bubbles at the filter disposed at the place other than the inside of the de-foaming chamber 263 can be suppressed, the air bubbles BL in the ink supply device 200 can be excellently removed. That is, as described above, since the air bubbles BL move to the de-foaming chamber 263 without being retained at the filter section 240 and are retained only at the de-foaming chamber 263, the air bubbles BL can be excellently removed from the ink supply device 200 by the de-foaming action in the de-foaming chamber 263.

In the ink supply device 200 according to the second embodiment, since the de-foaming chamber 263 adjoins the depressurized chamber 264 with the partition portion 268, which is disposed at the ceiling portion of the upper space 263u, interposed therebetween, the air bubbles BL captured (trapped) by the filter 263f can be excellently removed. Specifically, since the air bubbles BL mixed in ink of the de-foaming chamber 263 are captured (trapped) by the filter 263f, they are retained in the upper space 263u. As described above, since the partition portion 268 is disposed in the upper space 263u, the air bubbles BL can be excellently removed. Further, since the partition portion 268 is disposed at the ceiling portion of the upper space 263u and the air bubbles BL move to the partition portion 268 due to buoyancy, the air bubbles BL can be further excellently removed.

In the ink supply device 200 according to the second embodiment, since the valve unit 250 is provided between the filter section 240 and the de-foaming chamber 263, the air bubbles in ink can be excellently removed. Specifically, ink between the valve unit 250 and the flow path pump section 220 can be maintained in a pressurized state by sealing the ink flow path FC by the valve unit 250, and then pressurizing ink by the flow path pump section 220. Therefore, the air bubbles BL can be prevented from being mixed in ink due to the entering of air into the ink flow path FC. Further, the de-foaming chamber 263 can have a sealed state due to the driving of the depressurizing pump portion 230. Therefore, gas constituting the air bubbles BL can be moved from ink in the de-foaming chamber 263 to the depressurized chamber 264 side by using the differential pressure between the de-foaming chamber 263 and the depressurized chamber 264, so that the air bubbles BL can be excellently removed from the de-foaming chamber 263.

In the ink supply device 200 according to the second embodiment, since the pressure chamber 262 adjoins the depressurized chamber 264, the air bubbles BL in ink can be excellently removed. Specifically, since the pressure chamber 262 adjoins the depressurized chamber 264, the volumes of the pressure chamber 262 and the de-foaming chamber 263 can be suppressed, so that the air bubbles BL in ink can be excellently removed by making the de-foaming chamber 263 a sealed state. Further, since the valve unit 250 adjoins the depressurized chamber 264, the volumes of the pressure chamber 262 and the de-foaming chamber 263 are suppressed, so that the air bubbles BL in ink can be excellently removed.

In the ink supply device 200 according to the second embodiment, since the de-foaming chamber 263 is arranged such that the de-foaming chamber introduction port 263c is disposed at a position with a height equal to or more than that of the de-foaming chamber discharge port 263x in the vertical direction and that the filter 263f is disposed between the de-foaming chamber introduction port 263c and the de-foaming chamber discharge port 263x, the air bubbles BL in ink can be excellently removed. Specifically, since the de-foaming chamber introduction port 263c is disposed at a position with a height equal to or more than that of the de-foaming chamber discharge port 263x, the air bubbles can be easily captured (trapped) by the filter 263f due to buoyancy, so that the air bubbles BL can be excellently removed through the partition portion 268.

### Third Embodiment

In the third embodiment, a case where the same printer 10 as that of the second embodiment is used in a different position from that in the second embodiment is explained. The printer 10 can be used in two different positions such as a lengthwise-mounted position and a transverse-mounted position. That is, the printer 10 can perform printing not only in the first position described in the second embodiment, but also in the second position turned by the angle of 90 degrees from the first position.

FIG. 16 is an explanatory view illustrating the second position of the filter section. Since the filter section 240 is disposed such that the axis OX is out of alignment with the axis IX, also in the second position, the discharge port 244 is in a state where it is disposed at a higher position than the introduction port 243 in the vertical direction. Further, since in the first position, the discharge port 244 is disposed biased so as to follow the end of one side of the filter chamber 242 in the horizontal direction, also in the second position, the discharge port 244 is in a state where it is disposed in contact with the uppermost portion UL of the filter chamber 242.

Also in the second position, similarly to the first position, ink flowed-in from the introduction port 243 moves to the discharge port 244 side (the right upward direction in FIG. 16), passes through the filter 241, thereby being filtered, and then is discharged out of the discharge port 244. When the ink is filtered by the filter 241, some of the air bubbles BL mixed in ink are captured (trapped) at the upper portion on the introduction port 243 side of the filter 241. However, since the flow path pump section 220 pressure-feeds ink such that the sum of the force applied to the air bubbles BL due to the pressure-feeding of ink and the buoyancy of the air bubbles BL captured by the filter 241 is higher than the resisting force of the captured air bubbles BL, the air bubbles BL captured by the filter 241 are not retained at the introduction port 243 side of the filter 241, pass through the filter 241, and then move to the discharge port 244 side. Further, since the side 242w of the filter chamber 242 is formed into a tapered shape, the air bubbles are discharged from the discharge port 244 along the side 242w.

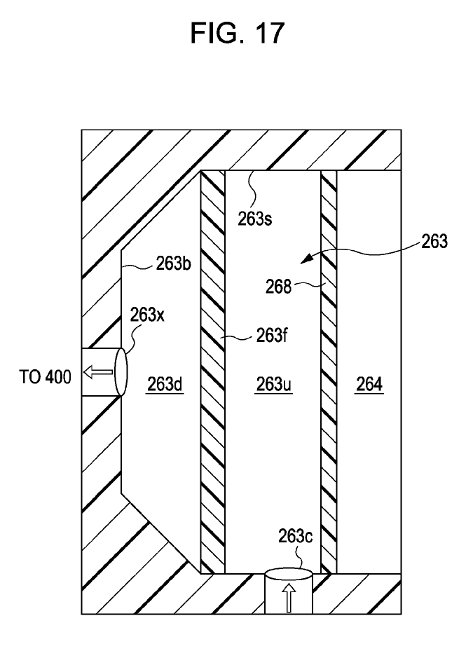

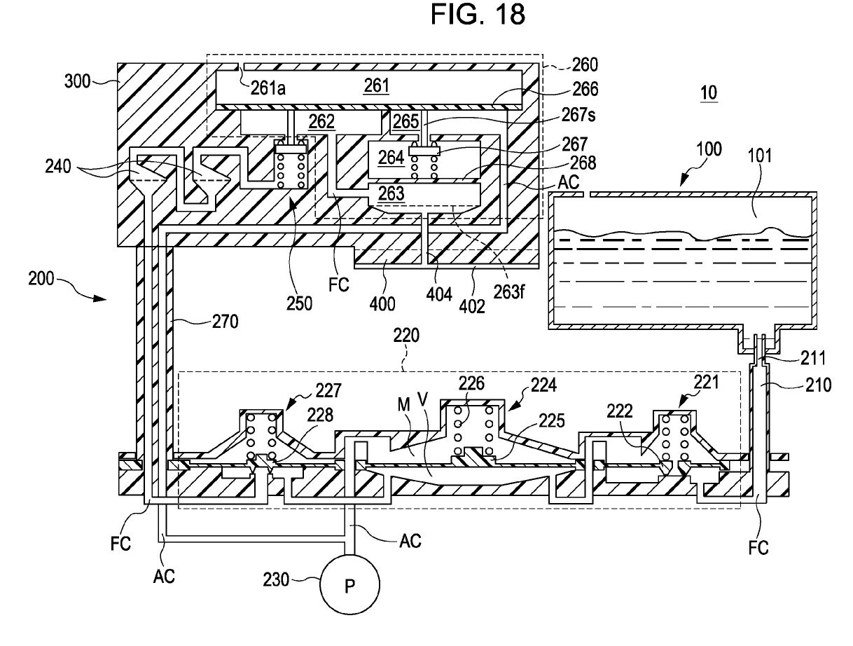

FIG. 17 is an explanatory view illustrating the second position of the de-foaming chamber. As shown in FIG. 17, in the de-foaming chamber 263 of the second position, the de-foaming chamber introduction port 263c is disposed at the lower position of the de-foaming chamber 263 in the vertical direction. Ink in the de-foaming chamber 263 moves toward the de-foaming chamber discharge port 263x (in the left direction of FIG. 17) by being sucked out from the de-foaming chamber discharge port 263x, and passing through the filter 263f, thereby being filtered. When ink is filtered by the filter 263f, some of the air bubbles BL mixed in ink are captured (trapped) by the filter 263f in the upper space 263u which is located at the right in FIG. 17. The captured air bubbles BL are removed through the partition portion 268.

In the printer 10 according to the third embodiment, also in the second position, the discharge port 244 is disposed at a position with a height equal to or more than that of the introduction port 243 in the vertical direction. Therefore, the printer 10 can excellently remove the air bubbles in ink from the filter section 240 in two different positions in which the printer can perform printing.

In the printer 10 according to the third embodiment, also in the second position, it is possible to remove the air bubbles in ink through the partition portion 268 by retaining them in the upper space 263u of the de-foaming chamber 263. Therefore, the printer 10 can excellently remove the air bubbles in ink by the de-foaming chamber 263 in two different positions in which the printer can perform printing.

### MODIFICATION EXAMPLES

In addition, the invention is not to be limited to the examples and the embodiments described above, but can be implemented in various aspects within the scope not departing from the essential points thereof, and, for example, the following modification examples are also possible.

### Modification Example 1

FIG. 18 is an explanatory view illustrating the schematic configuration of the printer 10 according to Modification Example 1. Although the ink supply device 200 in the above embodiments has one filter section 240, the number of filter section 240 is not limited to one, but two filter sections 240 may also be provided, as shown in FIG. 18, and the filter sections 240 of the numbers more than two may also be provided. Further, the filter sections 240 may also be provided at a place other than the carriage 300. Also in this case, retention of the air bubbles BL at each filter section is suppressed, so that the air bubbles BL move to the de-foaming chamber 263 and are retained only at the de-foaming chamber 263. Therefore, the air bubbles BL can be excellently removed from the ink supply device 200 by the de-foaming action.

### Modification Example 2

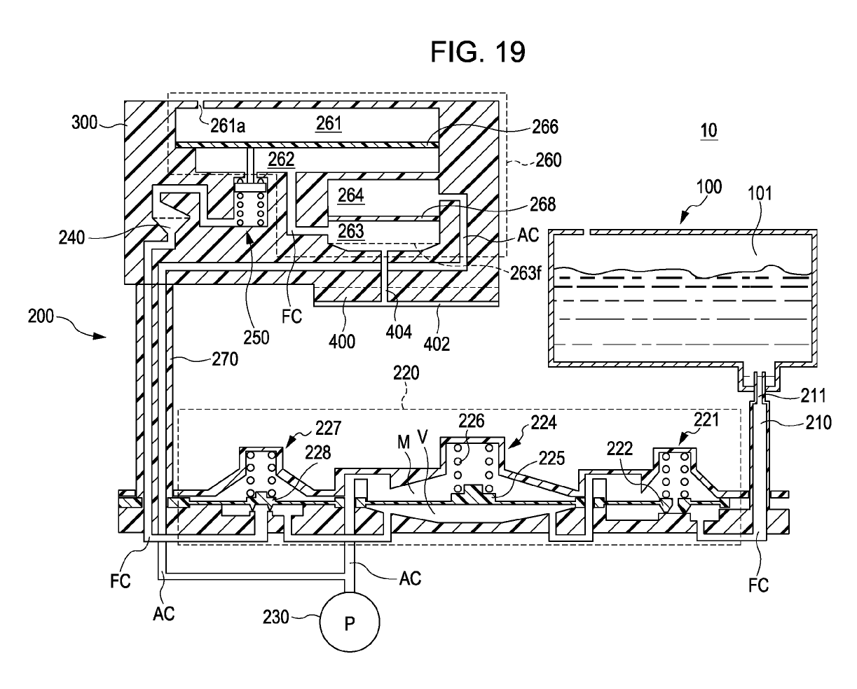

FIG. 19 is an explanatory view illustrating the schematic configuration of the printer 10 according to Modification Example 2. Although the ink supply device 200 according to the above embodiments has the negative-pressure chamber 265 and the flow path valve 267, they may also be omitted, as shown in FIG. 19.

### Modification Example 3

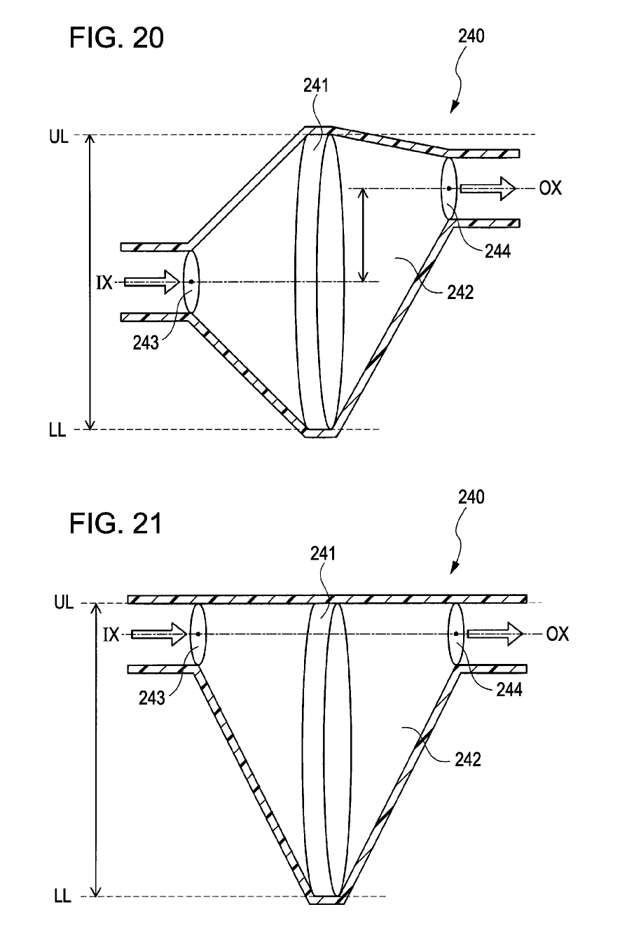

FIG. 20 is an explanatory view illustrating the configuration of the filter section according to Modification Example 3. In the above embodiments, in the filter section 240, the discharge port 244 is disposed at the uppermost portion UL. However, provided that its position thereof in the vertical direction is higher than that of the introduction port 243, the discharge port 244 may also be disposed at a portion other than the uppermost portion UL, as shown in FIG. 20. Also in this case, since the air bubbles BL in the filter chamber 242 are discharged from the discharge port 244, the air bubbles in ink can be excellently removed.

### Modification Example 4

FIG. 21 is an explanatory view illustrating the configuration of the filter section according to Modification Example 4. In the above embodiments, in the filter section 240, the discharge port 244 is disposed at a higher position than the introduction port 243 in the vertical direction. However, for example, as shown in FIG. 21, the discharge port 244 and the introduction port 243 may also be disposed at the position of the same height in the vertical direction. In this case, it is more preferable that the discharge port 244 and the introduction port 243 be near to the uppermost portion UL.

### Modification Example 5

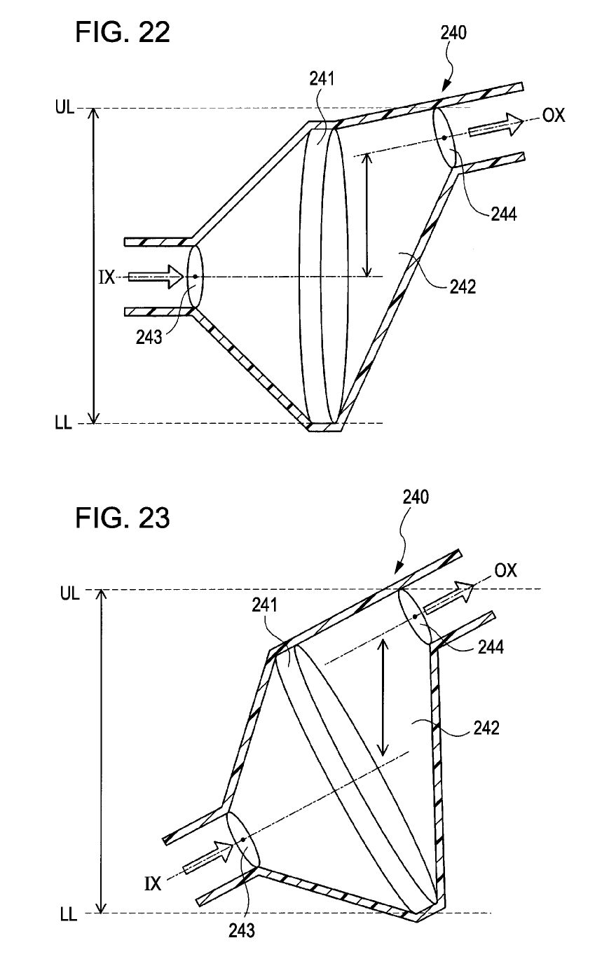

FIG. 22 is an explanatory view illustrating the configuration of the filter section according to Modification Example 5. In the above embodiments, the filter section 240 is disposed such that the axis OX of the discharge port 244 and the axis IX of the introduction port 243 are parallel to each other. However, for example, as shown in FIG. 22, the axis OX of the discharge port 244 and the axis IX of the introduction port 243 may also not be parallel to each other. Also in this case, since the air bubbles BL are discharged from the discharge port 244, the air bubbles in ink can be excellently removed.

### Modification Example 6

FIG. 23 is an explanatory view illustrating the configuration of the filter section according to Modification Example 6. In the above embodiments, the second position of the filter section 240 is the position turned by the angle of 90 degrees from the first position. However, the second position is not limited to this, but, provided that the discharge port 244 is disposed at a position with a height equal to or more than that of the introduction port 243 in the vertical direction, the position turned by any angle from the first position, for example, as shown in FIG. 23 may also be adopted as the second position.

### Modification Example 7

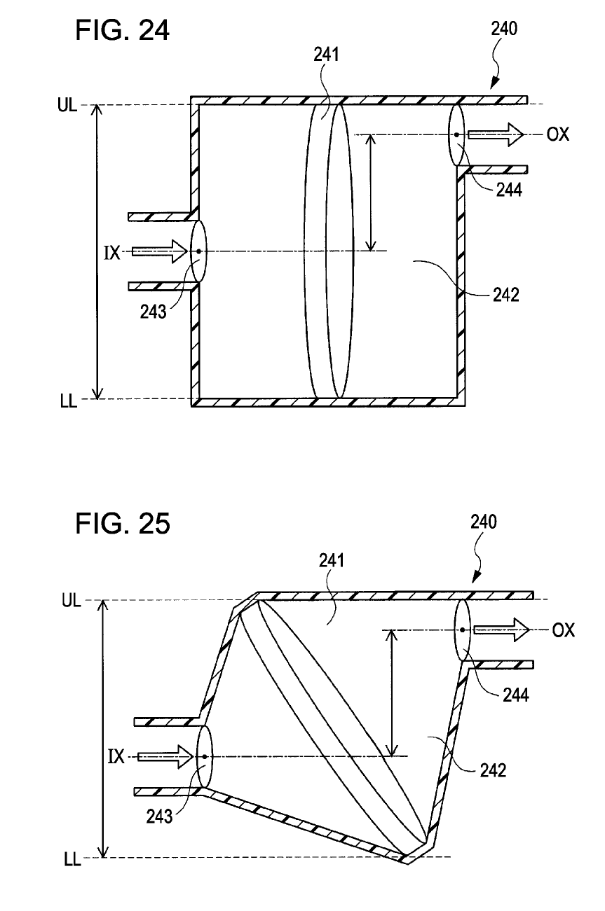

FIG. 24 is an explanatory view illustrating the configuration of the filter section according to Modification Example 7. In the above embodiments, the side 242w of the filter section 240 is formed into a tapered shape not only between the filter 241 and the introduction port 243, but also between the filter 241 and the discharge port 244. However, the side may not be of a tapered shape, as shown in FIG. 24. Further, only any one of the sides between the filter 241 and the introduction port 243 and between the filter 241 and the discharge port 244 may also be formed into a tapered shape. Further, also in this case, it is more preferable that the discharge port 244 be near to the uppermost portion UL.

### Modification Example 8

FIG. 25 is an explanatory view illustrating the configuration of the filter section according to Modification Example 8. Although in the above embodiments, the filter 241 of the filter section 240 is disposed in an approximately horizontal or vertical direction in the vicinity of the center of the filter chamber 242, it is not limited to this, but the filter 242 may also be disposed at any position and angle in the filter chamber 242, as shown in FIG. 25. In addition, also in terms of the relationship between the discharge port 244 and the introduction port 243, any position and angle may also be adopted.

### Modification Example 9

In the above embodiments, in the filter section 240, the entire discharge port 244 is disposed at a higher position than the introduction port 243. However, the comparison in height between the discharge port 244 and the introduction port 243 may also be performed by the comparison in height at any portion of the respective ports. For example, it may also be performed by the comparison in height between the upper or lower ends of the respective ports. Also in terms of the de-foaming chamber introduction port 263c and the de-foaming chamber discharge port 263x, the same is true.

### Modification Example 10

Although in the above embodiments, the depressurizing pump portion 230 is configured to be disposed for each of four colors (black, cyan, magenta, and yellow) instead of this, an aspect may also be adopted in which the depressurizing pump portion 230 is shared with respect to all colors. Further, also in terms of the flow path pump section 220, it is not provided for each of four colors, but an aspect may also be adopted in which the flow path pump section 220 is shared with respect to all colors. In addition, although the kind of ink discharged by the printer is described as being four colors, instead of this, a configuration may also be adopted in which any kind of ink is discharged.

### Modification Example 11

Although in the printer 10 according to the above embodiments, the upper space region M of the pump 224 and the negative-pressure chamber 265 of the reduced-pressure de-foaming section 260 have a negative-pressure state by the common depressurizing pump portion 230, the upper space region M of the pump 224 and the negative-pressure chamber 265 of the reduced-pressure de-foaming section 260 may also have a negative-pressure state generated by separate pumps.

### Modification Example 12

Although in the printer 10 according to the above embodiments, the filter section 240, the valve unit 250, and the reduced-pressure de-foaming section 260 are mounted on the carriage 300, the components of the ink supply device 200 to be mounted on the carriage 300 are not limited to these components, but an aspect may also be adopted in which, for example, the filter section 240 is not mounted on the carriage 300.

### Modification Example 13

Although in the printer 10 according to the above embodiments, the upper space region M of the pump 224 and the negative-pressure chamber 265 of the reduced-pressure de-foaming section 260 have a negative-pressure state generated by the common depressurizing pump portion 230, the upper space region M of the pump 224 and the negative-pressure chamber 265 of the reduced-pressure de-foaming section 260 may also have a negative-pressure state generated by separate pumps.

### Modification Example 14

Although in the embodiments described above, the ink jet type printer has been described, the invention is not limited to this, but can also be applied to any liquid ejecting apparatus which ejects liquid other than ink. For example, the invention can be applied to an image recording apparatus such as a facsimile apparatus; a color material ejecting head used in the manufacturing of the color filter for liquid crystal displays or the like; an electrode material ejecting apparatus used in the forming of the electrodes of an organic EL (Electro Luminescence) display, a field emission display (FED), or the like; a liquid ejecting apparatus which ejects liquid containing a bioorganic material used in the manufacture of a bio-chip; a sample ejecting apparatus as a precision pipette; and the like. Further, the invention can also be applied to a liquid ejecting apparatus which ejects lubricant oil to a precision machine such as a clock and a camera by a pinpoint; a liquid ejecting apparatus which ejects transparent resin liquid such as ultraviolet curable resin on a substrate in order to form a minute hemispherical lens (optical lens) or the like used in an optical communication element or the like; and a liquid ejecting apparatus which ejects etching liquid such as acid or alkali in order to etch a substrate or the like. In addition, the invention can also be applied to the ejecting apparatus of any one of various liquid ejecting apparatuses which is provided with a liquid ejecting head or the like that discharges a minute amount of liquid droplet.

Incidentally, the liquid droplet refers to a liquid state which is discharged from the liquid ejecting apparatuses, and is intended to also include a granular shape, a tear shape, and a shape elongated in a string shape. Further, if liquid as mentioned herein is a material which can be ejected by a liquid ejecting apparatus, it is appropriate. For example, if a material is that of a state of a liquid phase, it is appropriate, and other than liquid as one state of substance, a liquid state having high or low viscosity; a fluid state such as a sol, gel water, an inorganic solvent, an organic solvent, solution, liquid resin, and a liquid metal (metal melt); and a material in which the particles of a functional material including a solid matter such as pigment or a metal particle are dissolved, dispersed, or mixed in a solvent are also included. Further, as a typical example of liquid, ink as described in the above embodiments and examples, liquid crystal, and the like can also be given. Here, ink is intended to include various liquid compositions such as general aqueous ink, oily ink, gel ink, and hot-melt ink.

What is claimed is:

1. A liquid supply device comprising:
a de-foaming chamber for removing air bubbles mixed in liquid;
a liquid flow path which supplies the liquid to the de-foaming chamber;
a filter section provided in the liquid flow path and having an introduction portion for introducing the liquid and a discharge portion for discharging the liquid, where the discharge portion is disposed at a position with a height equal to or more than that of the introduction portion in the vertical direction; and
a pressurizing section for supplying the pressurized liquid to the filter section.

2. The liquid supply device according to claim 1, wherein the de-foaming chamber is provided with a first filter through which the liquid passes.

3. The liquid supply device according to claim 2, further comprising:
a depressurized chamber which can have a negative-pressure state,
wherein the de-foaming chamber has two inner spaces partitioned by the first filter, and the upstream side space of the spaces adjoins the depressurized chamber with a transmission wall having gas permeability interposed therebetween.

4. The liquid supply device according to claim 3, further comprising:
a sealing valve which is provided in the liquid flow path between the filter section and the de-foaming chamber and can seal the liquid flow path.

5. The liquid supply device according to claim 4, wherein the sealing valve adjoins the depressurized chamber.

6. The liquid supply device according to claim 5, wherein the filter section includes a second filter which is disposed such that the liquid passes upward from the lower side of the vertical direction.

7. The liquid supply device according to claim 6, wherein the first filter is disposed such that the liquid passes downward from the upper side of the vertical direction in the de-foaming chamber.

8. A liquid ejecting apparatus for ejecting liquid, comprising:
the liquid supply device according to claim 1; and
a head section which ejects liquid supplied from the liquid supply device.
